(19) United States
(12) Patent Application Publication
(10) Pub. No.: US 2006/0222407 A1
(43) Pub. Date: Oct. 5, 2006

(54) Wet type image forming apparatus and developing unit thereof

(75) Inventor: Motohiro Maseki, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/392,745

(22) Filed: Mar. 30, 2006

(30) Foreign Application Priority Data
Mar. 31, 2005 (JP) 2005-100701

(51) Int. Cl. G03G 15/10

(52) U.S. Cl. 399/249

(57) ABSTRACT

A developing unit for a wet type image forming apparatus that forms an image with developing solution containing toner in carrier solution is provided. The developing unit includes a latent image carrying roller on which a latent image is developed with the toner, a developing solution carrying roller that is charged and thereby carries the developing solution to supply the developing solution to the latent image carrying roller, a developing solution scraping unit that scrapes off a portion of the developing solution that is not used for developing, and a shearer that is arranged at a position in a path of the scraped developing solution, and applies shearing stress to a piece of toner coating. The piece of toner coating is formed with the scraped developing solution.

### BACKGROUND OF THE INVENTION

The present invention relates to a developing unit for a wet type image forming apparatus that forms an image with a developing solution.

Apparatuses that transfer toner to a recording sheet to thereby form an image include, for example, a dry type image forming apparatus, which applies powder toner to a surface of a developing roller to form an image, and a wet type image forming apparatus, which applies developing solution containing toner in carrier solution to a surface of a developing roller to form an image, as disclosed in Japanese Patent Provisional Publication No. P2002-14541A. The toner employed in the latter apparatus is finer than that employed in the former. Accordingly, the latter provides an image of a higher quality.

As disclosed in the above-referenced publication, a conventional wet type image forming apparatus is generally equipped with a developing unit including a solution applying roller (for example, an anilox roller) that applies developing solution onto a developing roller, the developing roller, and a photoconductive drum, and the developing solution is carried in the same sequence in the developing unit. In a vicinity to the developing roller, of which surface of is formed of an electrically conductive member, a corona charger is provided, and with the electricity of the corona charger, the surface of the developing roller is evenly charged. The developing solution applied to the developing roller by the solution applying roller is separated by the charged effect of the developing roller into two layers; a layer containing only carrier solution (which will be hereinafter referred to as a carrier layer) and a layer containing high-density toner (which will be hereinafter referred to as a toner layer). The developing solution is then carried to a contacted interface between the developing roller and the photoconductive drum with the toner layer remaining on the surface of the developing roller.

On a surface of the photoconductive drum, a latent image corresponding to the print information is formed by laser beam or the like before the rotated surface arrives to the contacted interface. When the photoconductive drum with the latent image is brought into contact with the developing roller and the developing solution, the toner in the developing solution is adhered only to a region corresponding to the latent image on the photoconductive drum due to an electrical potential difference between a lower potential region (i.e. the region where the latent image exists) and a higher potential region (a region excluding the latent image) caused by an effect of the laser beam. The adhered toner is then transferred to a recording media via a recording media feeding unit. Thus, the latent image on the photoconductive drum is developed to turn into a toner image.

The developing solution containing the toner, which has not been utilized in the developing process, is scraped off by a developing roller cleaning blade disposed in contact with the surface of the developing roller, and collected into a collecting tank, which is disposed under the rollers. The collected developing solution is carried by a circulator such as a pump and a screw to a storage tank, wherein the toner density of the solution is readjusted for reuse. It should be noted that there is also provided an image forming apparatus without the circulator and the storage tank, so that the used solution is not carried and the toner density is readjusted in the collecting tank disposed under the rollers. In this configuration, the collecting tank also serves as the storage tank.

As described above, the developing solution applied to the developing roller is separated into the carrier layer and the toner layer. As viscosity of the carrier layer is relatively low, the carrier solution scraped off by the developing roller cleaning blade or falling by itself is easily collected in the collecting tank. The toner layer with the toner in higher density is concentrated even more on the surface of the developing roller due to the charged electricity and has a relatively high viscosity and hence a lower fluidity. Therefore, when the toner layer is scraped by the developing roller cleaning blade, a path of the toner ranging from a contact portion of the developing roller cleaning blade and the developing roller to the collecting tank is coated with the toner (i.e., so-called “toner coat” is formed).

If the toner coat is left untreated, troubles in collecting and reusing the used solution may occur, such that the toner density is not properly adjusted in the storage tank. Further, the toner coat deposited on a bottom of the collecting tank may overflow from the deposited on the developing roller cleaning blade may deteriorate cleaning capability of the blade. However, it should be noted that the toner coat as described above has not been taken up for improvement in the developing unit of the conventional wet type image forming apparatuses.

### SUMMARY OF THE INVENTION

In view of the foregoing situation, the present invention is advantageous in that an improved wet type image forming apparatus is provided, of which a developing unit is capable of removing the toner coat generated in the path of the used toner ranging from the contact portion of the developing roller cleaning blade and the developing roller to the collecting tank.

According to aspects of the invention, there is provided a developing unit for a wet type image forming apparatus that forms an image with developing solution containing toner in carrier solution. The developing unit includes a latent image carrying roller on which a latent image is developed with the toner, a developing solution carrying roller that is charged and thereby carries the developing solution to supply the developing solution to the latent image carrying roller, a developing solution scraping unit that scrapes off a portion of the developing solution that is not used for developing, and a shearer that is arranged at a position in a path of the scraped developing solution, and applies shearing stress to a piece of toner coating. The piece of toner coating is formed with the scraped developing solution.

Optionally, the shearer may include a cylindrical roller that is configured to rotate about an axis, the axis being in parallel to a rotation axis of the developing solution carrying roller.

Optionally, the cylindrical roller may be arranged in a vicinity of the latent image carrying roller, and may rotate in the same direction with a rotation direction of the latent image carrying roller so that the carrier solution adhered to the latent image carrying roller is squeezed by the cylindrical roller.

Optionally, the cylindrical roller may be arranged in a vicinity of the latent image carrying roller, and may be charged to gain a higher potential than a region of the latent image carrying roller in which the latent image exists, so that the toner adhered to the latent image carrying roller is stuck to the latent image carrying roller.

Optionally, the developing unit may further include a collecting tank that has a portion located under at least the latent image carrying roller and the developing solution scraping unit to collect a portion of the developing solution, a conveyer that is arranged in the collecting tank to carry the developing solution collected in the collecting tank to a storing tank wherein density of toner in the developing solution is adjusted. The shearer may be the conveyer.

Optionally, the conveyer may be a helical member that is adapted to rotate about an axis parallel to the rotation axis of the developing solution carrying roller.

According to aspects of the invention, there is provided a wet type image forming apparatus that forms an image with developing solution containing toner in carrier solution. The wet type image forming apparatus includes a developing unit having a latent image carrying roller on which a latent image is developed with the toner, a developing solution carrying roller that is charged and thereby carries the developing solution to supply the developing solution to the latent image carrying roller, a developing solution scraping unit that scrapes off a portion of the developing solution that is not used for developing, and a shearer that is arranged at a position in a path of the scraped developing solution, and applies shearing stress to a piece of toner coating. The piece of toner coating is formed with the scraped developing solution. The wet type image forming apparatus further includes a carrying unit that carries a recording sheet to a discharging opening of the wet type image forming apparatus via the latent image carrying roller, and a controller that controls the developing unit and the carrying unit so that a predetermined image is formed on a surface of the recording sheet.

### BRIEF DESCRIPTION OF THE ACCOMPANYING DRAWINGS

FIG. 1 is a cross-sectional side view showing a structure of a wet type printer according to an embodiment of the present invention.

FIG. 2 is an enlarged cross-sectional side view showing a structure around a developing unit in the wet type printer according to the embodiment of the present invention.

FIG. 3 an enlarged cross-sectional side view showing a structure around the developing unit in the wet type printer according to an embodiment of the present invention.

FIG. 4 is a perspective view snowing a shearer in a wet type printer according to another embodiment of the present invention.

### DETAILED DESCRIPTION OF THE EMBODIMENTS

Referring to the accompanying drawings, a wet type printer according to an embodiment of the present invention will be described in detail.

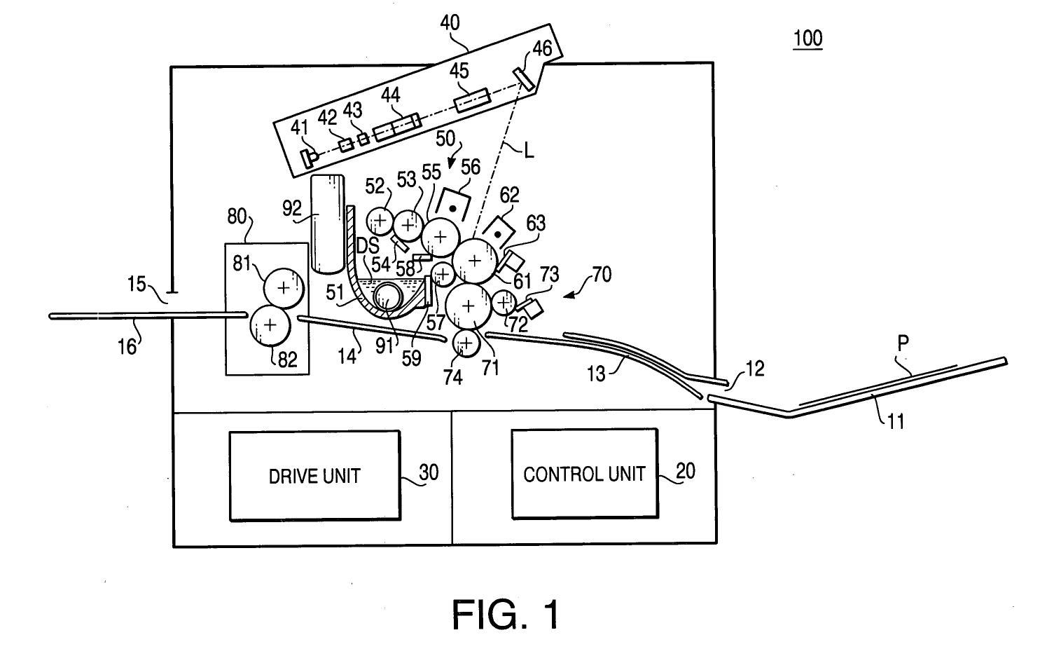

FIG. 1 is a cross-sectional side view showing a structure of a wet type printer 100 according to an embodiment of the present invention. The wet type printer 100 is an apparatus for forming an image having a developing roller that carries, on its surface, a developing solution DS containing toner in carrier solution, and more specifically an apparatus that receives print information (i.e., character and/or image information) from an external apparatus such as a computer, and prints out the characters or the images on a sheet of recording paper P in accordance with a so-called electrophotographic imaging process.

The wet type printer 100 generally includes a control unit 20 that controls a printing process, sheet feeding operation and so on, a driving unit 30 that drives various mechanisms, a laser scanning unit (hereinafter abbreviated as “LSU”) 40 that outputs a laser beam modulated according to print information, a developing unit 50 that develops a latent image formed according to the print information with the developing solution DS, a transfer unit 70 that transfers a toner image developed by the developing unit 50 at a transfer position onto the recording paper P, feeding mechanisms 11, 12, 13, 14 that feed the recording paper P, and a fixing unit 80 that permanently fixes the toner image which has been transferred on the recording paper P.

The driving unit 30 serving as a driving source of the mechanisms in the wet type printer 100 includes a plurality of actuators that drive the respective mechanisms. All of these actuators are connected to the control unit 20, to be driven under the control of the control unit 20. The driving unit 30 can cause a rotation of, for example, a developing roller 55 as a developing solution carrying roller and a photoconductive drum 61 as a latent image carrying roller included in the developing unit 50, and a heat roller 81 included in the fixing unit 80.

On a side face of a housing of the wet type printer 100, a paper inlet 12 is formed, through which the recording paper P is introduced into the printer 100, and a paper tray 11 for storing the recording paper P is attached at the paper inlet 12. On the opposite-side face of the housing, a paper outlet 15 and a receiver tray 16 are provided. The recording paper P, upon being introduced into the wet type printer 100 through the paper inlet 12, is fed along a paper path 13 to reach the transfer position defined by the transfer unit 70, where the toner image is transferred onto the surface of the recording paper P. Thereafter the recording paper P is fed along a paper path 14 to reach a fixing position defined by the fixing unit 80 for fixation of the toner image. Then, the recording paper P is discharged from the wet type printer 100 through the paper outlet 15.

The LSU 40, as an exposure system for forming a latent image on a surface of the photoconductive drum 61, includes a laser diode 41 serving as a light source, a collimating lens 42, a cylindrical lens 43, a polygon mirror 44, an imaging lens 45 and a deflecting mirror 46. Instead of the LSU 40, an LED (Light Emitting Diode) and a reducing optical system may be employed as the exposure method.

The laser diode 41 is driven under the control of the control unit 20. That is, the laser diode 41 is turned on and off according to the print information, thereby emitting a laser beam L modulated carrying the image information. The laser beam L (indicated by dashed lines) irradiated by the laser diode 41 enters the collimating lens 42, which converts the laser beam L from a diffused light into a parallel luminous flux.

The laser beam L converted into a parallel luminous flux is converged by the cylindrical lens 43 solely in a sub-scanning direction so that the laser beam L is converged on a plane, in the sub-scanning direction, close to a reflecting surface of the polygon mirror 44. It is to be noted that the sub-scanning direction herein referred to designates a direction in parallel with a sheet-transporting direction shown FIG. 1 (a direction perpendicular to a rotating axis of the photoconductive drum 61, i.e. a tangent on a circumferential surface thereof), while a direction perpendicular to the sub-scanning direction, i.e. a direction in which the laser beam L is scanned on the photoconductive drum 61 (an axial direction on the photoconductive drum 61) is herein defined as a main scanning direction.

The polygon mirror 44 is rotated by a motor (not shown), and hence the laser beam L linearly converged (converged only in a sub-scanning direction) by the cylindrical lens 43 substantially at a section of the reflecting surface of the polygon mirror 44 is deflected so as to be scanned in the main scanning direction, and enters the imaging lens 45. The laser beam L passed through the image forming lens 45 scans in the main scanning direction at a predetermined speed on the photoconductive drum 61. The laser beam L thus converted is deflected by the deflecting mirror 46 toward the photoconductive drum 61, to thereby form the image on the photoconductive drum 61. At this stage, since the laser beam L is modulated with the progress of the main scanning, a scanning line according to the print information is formed on the photoconductive drum 61. Also, since the photoconductive drum 61 rotates in a sub-scanning direction, a plurality of scanning lines are formed in the sub-scanning direction on the photoconductive drum 61. As a result, a two-dimensional latent image corresponding to the print information is formed on the photoconductive drum 61. It should be noted that the reflecting surface of the polygon mirror 44 and the photoconductive drum 61 have a conjugate relationship with respect to the sub-scanning direction. Accordingly, the scanning line spacing is not shifted in a sub-scanning direction, even when the polygon mirror 44 incurs a facet error.

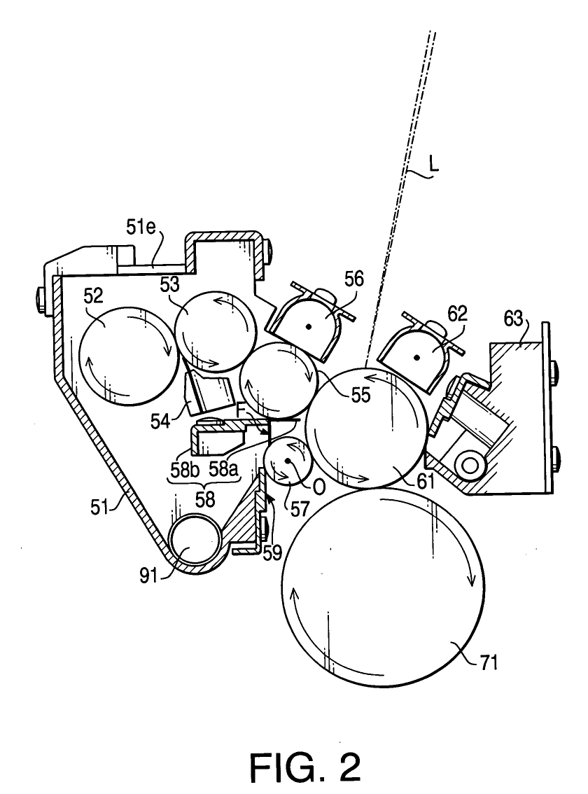

FIG. 2 is an enlarged cross-sectional side view showing a structure around the developing unit 50 in the wet type printer 100 according to the embodiment of the present invention. The developing unit 50 includes a collecting tank 51, an add roller 52, a measuring roller 53, an adjusting blade 54, the developing roller 55, a developing roller corona charger 56, a squeeze roller 57, a developing roller cleaning unit 58, a squeeze roller cleaning blade 59, the photoconductive drum 61, a photoconductive drum corona charger 62, and a photoconductive drum cleaning blade 63. All of rotation axes of the respective rollers are in parallel with each other and are perpendicular to a direction parallel to a plane of FIG. 2, although rotating directions of the respective rollers vary.

Hereinafter, a flow of the developing solution DS inside the developing unit 50 as well as a developing process performed therein will be described.

In a solution storing tank 92 (see FIG. 1), the developing solution DS stored is agitated by an agitating mechanism (not shown) and the density of the developing solution DS is adjusted to be constant. When the image is formed, the developing solution DS is injected into the collecting tank 51 via a solution inlet 51e in a predetermined rate by a pumping mechanism (not shown). The injected developing solution DS is transitionally pooled in a dented portion formed by the add roller 52 that rotates in a clockwise direction shown in FIG. 2 and the measuring roller 53 that rotates in a counterclockwise direction shown in FIG. 2. Thereafter, the developing solution DS is supplied to a surface of the measuring roller 53 by the rotation of the measuring roller 53. The supplied developing solution 53 is partially scraped off and thereby adjusted by the adjusting blade 54 of which an edge is in contact with the surface of the measuring roller 53 so that excessive amount of the developing solution 53 is removed.

The measuring roller 53 is driven to rotate counterclockwise as shown in FIG. 2, and provided with a plurality of grooves formed at a predetermined interval on its surface. With this structure, a predetermined amount of the developing solution DS supplied to the measuring roller 53 remains in the grooves while the excessive amount of the developing solution 53 is scraped off by the adjusting blade 54. Therefore, the measuring roller 53 will carry the exactly measured amount of the developing solution DS, which will be transferred evenly to a surface of the developing roller 55 being in contact with the measuring roller 53.

The developing solution DS transferred to the surface of the developing roller 55 contains the toner in a uniform concentration, immediately after the application to the developing roller 55 from the measuring roller 53. The developing roller 55 rotates in the clockwise direction, according to the orientation of FIG. 2. Therefore, the developing solution DS having a uniform concentration is carried by the surface of the developing roller 55, to thereby pass under the developing roller corona charger 56.

The developing roller 55 has the surface constituted of a conductive material, so that such surface is uniformly charged by a corona charging effect of the developing roller corona charger 56. The charging effect generates an electric field between the surfaces of the developing roller 55 and the developing solution DS, thereby causing the toner, which has been uniformly distributed in the developing solution DS, to move toward the surface of the developing roller 55 and to closely stick thereto. In other words, the developing solution DS is separated into two layers, namely a layer containing only the carrier solution and the other layer containing the toner in a higher concentration than the initial state in the carrier solution. Obviously it is the latter layer that contacts the surface of the developing roller 55.

The developing solution DS separated into two layers then reaches to a position to contact the photoconductive drum 61. On the surface of the photoconductive drum 61, the latent image corresponding to the print information is formed, by the laser beam L emitted from the LSU 40. The photoconductive drum 61 is charged so as to gain a higher potential than that of the developing roller 55, by the photoconductive drum corona charger 62. However, the region where the latent image is formed gains a lower potential than the developing roller 55, due an effect of the laser beam L. Accordingly, between the region excluding the latent image on the photoconductive drum 61 and the surface of the developing roller 55, the toner remains closely stuck to the lower-potential region, i.e. the surface of the developing roller 55, without being transferred to the region where no latent image exists. Consequently, the region excluding the latent image is not developed. By contrast, between the latent image region on the surface of the photoconductive drum 61 and the surface of the developing roller 55, the toner performs electrophoresis toward the lower-potential region, i.e. the latent image region on the surface of the photoconductive drum 61, thus to adhere thereto. That is how the latent image on the photoconductive drum 61 is developed, to turn into a toner image.

The surface of the photoconductive drum 61, on which the toner image is formed, comes into contact with a surface of the squeeze roller 57. The squeeze roller 57 is arranged in a vicinity to the photoconductive drum 61, and is rotated in the same direction as the photoconductive drum 61 (i.e., the counterclockwise direction in FIG. 2). The carrier solution that has adhered to the surface of the photoconductive drum 61 together with the toner image is squeezed off by the squeeze roller 57. Such residual carrier solution is then removed from the surface of the squeeze roller 57 by the squeeze roller cleaning blade 59, and collected in the collecting tank 51, to be disposed of as used toner.

The squeeze roller 57 in the present embodiment of the invention is charged so as to gain a higher potential than that of the region of the surface of the photoconductive drum 61 where no latent image is formed. Accordingly, the toner image formed on the surface of the photoconductive drum 61 is even more closely stuck to the surface of the photoconductive drum 61 when the photoconductive drum 61 contacts the squeeze roller 57.

The toner image developed on the surface of the photoconductive drum 61 is transferred to the recording paper P by the transfer unit 70. The transfer unit 70 includes an intermediate transfer roll 71, a carrier solution squeeze roll 72, a carrier solution cleaning blade 73, and a secondary transfer roll 74.

To the intermediate transfer roll 71, a transfer bias of a reverse polarity to the toner is applied, so that the toner image developed on the surface of the photoconductive drum 61 is transferred as a primary step to the intermediate transfer roll 71, at the interface between the photoconductive drum 61 and the intermediate transfer roll 71. At this stage, a portion of the toner remaining on the surface of the photoconductive drum 61 without being transferred at the interface is scraped off from the surface by the photoconductive drum cleaning blade 63. Also, the carrier solution that has adhered to the surface of the intermediate transfer roll 71 together with the toner image is squeezed off from the surface by the carrier solution squeeze roll 72. Such residual carrier solution is then removed from the surface of the carrier solution squeeze roll 72 by the carrier solution cleaning blade 73.

The recording paper P on which the toner image has been transferred is carried to the fixing unit 80 along the paper path 14. The fixing unit 80 serves to apply heat and pressure to the recording paper P, so as to fix the toner image (i.e. the printing information) onto the recording paper P, and includes a heat roller 81 that heats up the recording paper P, and a press roller 82 opposing the heat roller 81 across the paper path, so as to hold the recording paper P in cooperation with the heat roller 81, thus to apply a pressure to the recording paper P. The recording paper P, on which the image according to the printing information has been fixed by the fixing unit 80, is discharged through the paper outlet 15.

The intermediate transfer roll 71 and the secondary transfer roll 74 are disposed so as to oppose to each other across a paper path for the recording paper P, and mutually abut at a predetermined nip pressure. The toner image transferred to the surface of the intermediate transfer roll 71 is transferred to the recording paper P being carried along the paper path at the interface with the secondary transfer roll 74, by the effect of a transfer electric field, the nip pressure and so on. The intermediate transfer roll 71, interposed between the secondary transfer roll 74 and the photoconductive drum 61, also serves to prevent the nip pressure of the secondary transfer roll 74 from being directly applied to the photoconductive drum 61. Further, the toner remaining on the surface of the intermediate transfer roll 71 after the transference to the recording paper P is removed by the intermediate transfer roll cleaning unit (not shown), and collected in a waste toner box (not shown), to be disposed of as waste toner.

The recording paper P on which the toner image has been transferred is carried to the fixing unit 80 along the paper path 14. The fixing unit 80 serves to apply heat and pressure to the recording paper P, so as to fix the toner image (i.e., the printing information) onto the recording paper P, and includes a heat roller 81 that heats up the recording paper P, and a press roller 82 located opposing to the heat roller 81 across the paper path, so as to hold the recording paper P in cooperation with the heat roller 81, thus to apply a pressure to the recording paper P. The recording paper P, on which the image according to the printing information has been fixed by the fixing unit 80, is discharged from the paper outlet 15.

Hereinafter, a process of removing the toner coat formed in the developing unit 50 will be described.

The residual solution of the developing solution DS containing the toner that was not used for developing when the toner image was developed by the developing roller 55 and the photoconductive drum 61 is lead to the developing roller cleaning unit 58 along the rotation of the developing roller 55. The developing roller cleaning unit 58 includes a conductive sheet 58a and a developing roller cleaning blade 58b.

The conductive sheet 58a is a thinly formed member in a material for example stainless steel and PET (polyethylene terephthalate). The conductive sheet 58a is in contact with the developing roller 55 at one end, and the other end is maintained to be charged to gain a lower potential than the charged developing roller 55. Therefore, the toner in the developing solution DS is directed to perform electrophoresis from the surface of the developing roller 55 toward the lower-potential end thereof, i.e., the conductive sheet 58a. Accordingly, when the developing solution DS is carried to the conductive sheet 58a, the carrier layer, which is one of the two layers in the developing solution DS, stays closer to the surface of the developing roller 55, while the toner layer, which is the other of the two layers, is further from the surface of the developing roller 55.

The toner that reached to the conductive sheet 58a is scraped off and removed from the surface of the developing roller 55 by the developing roller cleaning blade 58b of which edge is in contact with the developing roller 55. At this stage, the toner is floated on the carrier layer and separated from the surface of the developing roller 55 due to the above-described conductive effect of the conductive sheet 58a. Therefore, such toner can be effectively scraped off by the developing roller cleaning blade 58b without being accumulated in a vicinity of the developing roller cleaning blade 58b or passing through a small gap between the surface of the developing roller 55 and the developing roller cleaning blade 58b.

As viscosity of the carrier layer is relatively low, the carrier solution scraped off by the developing roller cleaning blade is easily collected in the collecting tank 51. The toner layer, however, has a relatively high viscosity and hence a lower fluidity. Therefore, a path of the toner is coated with toner, and the toner coat F extending downward from the developing roller cleaning blade 58b is formed.

As shown in FIG. 2, the squeeze roller 57 is arranged at a position in a path of the developing solution DS that is scraped off by the developing roller cleaning blade 58b. In other words, the squeeze roller 57 is located in an area where the toner coat F is formed. When the toner coat F extends downward and reaches to the squeeze roller 57, the squeeze roller 57 rotating in the counterclockwise direction in FIG. 2 applies shearing stress to the toner coat F so that the toner coat F is sequentially sheared. As a consequence, the sheared toner coat F is reversed into fluid, and the liquefied toner is held on the surface of the squeeze roller 57. As the squeeze roller 57 rotates, the toner is scraped off by the squeeze roller cleaning blade 59, and thereafter, collected in the collecting tank 51.

It should be noted that the squeeze roller 57 and the developing roller cleaning unit 58 are in a positional relation, as shown in FIG. 2, such that an rotation axis O of the squeeze roller 57 is displaced from the path of the toner coat F to be closer to the photoconductive drum 61. With this arrangement, when the toner coat F is sheared by the squeeze roller 57, the liquefied toner can be prevented from flowing toward the photoconductive drum 61 against the rotation of the squeeze roller 57.

The developing solution DS collected in the collecting tank 51 is carried by a helical roller 91, as a conveyer, which is provided with helical carvings on a surface thereof, to the solution storing tank 92 wherein the toner density of the developing solution DS is readjusted for reuse. The toner coat F has been effectively removed and liquefied by the squeeze roller 57, so that the collected developing solution DS can be easily carried by the helical roller 91. Therefore, the toner coat F is not accumulated in the collecting tank 51, unlike the conventional printing apparatuses.

As described above, the image forming apparatus 100 in the embodiment of the present invention employs the squeeze roller 57 as a shearer to apply shearing stress to the toner coat F for removal. It should be noted that a conventional roller is utilized as the shearer to apply shearing stress, so that a number of components in the apparatus may not necessarily be increased, as well as the apparatus can be prevented from becoming larger in size. Further, the squeeze roller 57 can agitate the toner coat F with the carrier solution squeezed from the surface of the photoconductive drum 61, so that the toner coat F can be even more effectively removed.

Although the present invention has been described based on the foregoing embodiment, it is to be understood that the present invention is not limited thereto, but various modifications may be made without departing from the scope of the present invention.

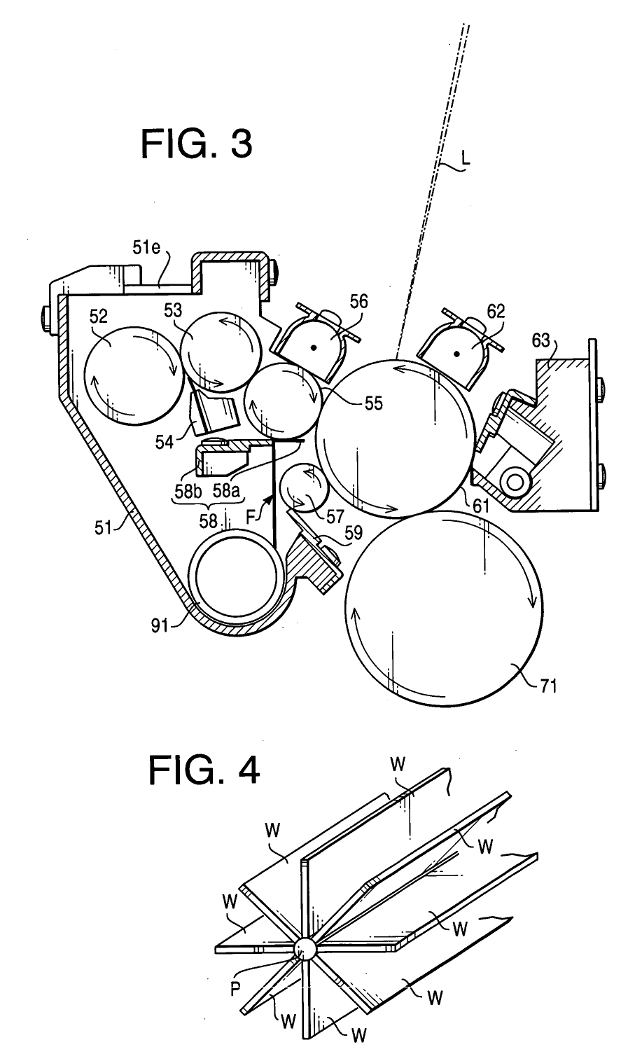

For example, in the foregoing embodiment, the squeeze roller 57 is used as the shearer to apply shearing stress to the toner coat F. However, the shearer in the invention is not limited to the squeeze roller. As shown in FIG. 3, the helical roller 91 may be used as the shearer. Further, a shearing roller dedicated to apply shearing stress to the toner coat F may be provided. The dedicated roller may not be necessarily be cylindrical, as long as the roller can apply shearing stress to the toner coat F. For example, as shown in FIG. 4, a louvered roller with a plurality of wings W extending evenly radially may be used.

Furthermore, in the foregoing embodiment, the developing solution DS collected in the collecting tank 51 is carried to the solution storing tank 92 by the helical roller 91. However, in the present invention, a configuration to collect used developing solution for reuse is not limited to the configuration described above. For example, the helical roller 91 may be substituted with a pump mechanism.

The present disclosure relates to the subject matter contained in Japanese Patent Application No. 2005-100701, filed on Mar. 31, 2005, which is expressly incorporated herein by reference in its entirety.

What is claimed is:

1. A developing unit for a wet type image forming apparatus that forms an image with developing solution containing toner in carrier solution, comprising:
a latent image carrying roller on which a latent image is developed with the toner,
a developing solution carrying roller that is charged and thereby carries the developing solution to supply the developing solution to the latent image carrying roller,
a developing solution scraping unit that scrapes off a portion of the developing solution that is not used for developing, and
a shearer that is arranged at a position in a path of the scraped developing solution, and applies shearing stress to a piece of toner coating, the piece of toner coating being formed with the scraped developing solution.

2. The developing unit according to claim 1, wherein the shearer includes a cylindrical roller that is configured to rotate about an axis, the axis being in parallel to a rotation axis of the developing solution carrying roller.

3. The developing unit according to claim 2, wherein the cylindrical roller is arranged in a vicinity of the latent image carrying roller, and rotates in the same direction with a rotation direction of the latent image carrying roller so that the carrier solution adhered to the latent image carrying roller is squeezed by the cylindrical roller.

4. The developing unit according to claim 2, wherein the cylindrical roller is arranged in a vicinity of the latent image carrying roller, and is charged to gain a higher potential than a region of the latent image carrying roller in which the latent image exists, so that the toner adhered to the latent image carrying roller is stuck to the latent image carrying roller.

5. The developing unit according to claim 1, further comprising:
a collecting tank that has a portion located under at least the latent image carrying roller and the developing solution scraping unit to collect a portion of the developing solution,
a conveyer that is arranged in the collecting tank to carry the developing solution collected in the collecting tank to a storing tank wherein density of toner in the developing solution is adjusted,
wherein the shearer is the conveyer.

6. The developing unit according to claim 5, wherein the conveyer is a helical member that is adapted to rotate about an axis parallel to the rotation axis of the developing solution carrying roller.

7. A wet type image forming apparatus that forms an image with developing solution containing toner in carrier solution, comprising:
a developing unit having a latent image carrying roller on which a latent image is developed with the toner, a developing solution carrying roller that is charged and thereby carries the developing solution to supply the developing solution to the latent image carrying roller, a developing solution scraping unit that scrapes off a portion of the developing solution that is not used for developing, and a shearer that is arranged at a position in a path of the scraped developing solution, and applies shearing stress to a piece of toner coating, the piece of toner coating being formed with the scraped developing solution;
a carrying unit that carries a recording sheet to a discharging opening of the wet type image forming apparatus via the latent image carrying roller; and
a controller that controls the developing unit and the carrying unit so that a predetermined image is formed on a surface of the recording sheet.

8. The wet type image forming apparatus according to claim 7, wherein the shearer includes a cylindrical roller that is configured to rotate about an axis, the axis being in parallel to a rotation axis of the developing solution carrying roller.

9. The wet type image forming apparatus according to claim 8, wherein the cylindrical roller is arranged in a vicinity of the latent image carrying roller, and rotates in the same direction with a rotation direction of the latent image carrying roller so that the carrier solution adhered to the latent image carrying roller is squeezed by the cylindrical roller.

10. The wet type image forming apparatus according to claim 8, wherein the cylindrical roller is arranged in a vicinity of the latent image carrying roller, and is charged to gain a higher potential than a region of the latent image carrying roller in which the latent image exists, so that the toner adhered to the latent image carrying roller is stuck to the latent image carrying roller.

11. The wet type image forming apparatus according to claim 7, wherein the developing unit further including a collecting tank that has a portion located under at least the latent image carrying roller and the developing solution scraping unit to collect a portion of the developing solution, a conveyer that is arranged in the collecting tank to carry the developing solution collected in the collecting tank to a storing tank wherein density of toner in the developing solution is adjusted, wherein the shearer is the conveyer.

12. The wet type image forming apparatus according to claim 11, wherein the conveyer is a helical member that is adapted to rotate about an axis parallel to the rotation axis of the developing solution carrying roller.
